(19) United States
(12) Patent Application Publication
(10) Pub. No.: US 2002/0090196 A1
(43) Pub. Date: Jul. 11, 2002

(54) Arrangement having a modular unit and having means for starting and stopping the modular unit

(76) Inventor: Siegfried Wurzer, Traiskirchen (AT)

Correspondence Address: U.S. Philips Corporation, 580 White Plains Road, Tarrytown, NY, 10591, US

(21) Appl. No.: 10/024,767

(22) Filed: Dec. 19, 2001

(30) Foreign Application Priority Data
Dec. 20, 2000 (EP) 00890383.3

(51) Int. Cl. H04N 5/92; H04N 5/781

(52) U.S. Cl. 386/46; 386/125

(57) ABSTRACT

An arrangement (1) which can be activated for an operating time and which includes a modular unit (2) that can be started and stopped, and which includes stopping means (5) which are designed for stopping the started modular unit (2), has delay means (6) which are designed for delaying the stopping of the modular unit (2) in accordance with a run-out time during the operating time of the arrangement (1), and further has changing means (7) which are designed for changing the run-out time.

The invention relates to an arrangement which can be activated for an operating time and which includes a modular unit that can be started and stopped.

An arrangement corresponding to the generic type set forth at the beginning in the first paragraph has been marketed by the applicant and is therefore known. The known arrangement is a video recorder branded TIVO, the arrangement having as a modular unit a hard disk for recording and for reproducing data representing video signals. In the known video recorder, when the video recorder is connected to a supply voltage, the hard disk is started and is then available for recording and reproducing data, specifically until the known video recorder is disconnected from the supply voltage.

The known video recorder therefore has the problem that the hard disk is started during the entire operating time of the video recorder and, consequently, even when there is no recording or reproducing of data, an undesirably high energy consumption is caused and, furthermore, unnecessary wear of the hard disk occurs. Furthermore, the known video recorder has the problem that the hard disk, which is permanently in the started state, causes operating noise which can be perceived as unpleasant by a user of the video recorder.

It is an object of the invention to preclude the aforementioned problems in an arrangement of the type set forth at the beginning in the first paragraph and to provide an improved arrangement.

In order to achieve the object set forth above, in an arrangement corresponding to the generic type set forth at the beginning in the first paragraph, the invention provides features according to the invention such that an arrangement according to the invention is defined in the following way, specifically:

An arrangement which can be activated for an operating time and which includes a modular unit that can be started and stopped, and which includes stopping means which are designed for stopping the started modular unit, the stopping means having delay means which are designed for delaying the stopping of the modular unit in accordance with a run-out time during the operating time of the arrangement, and the stopping means having changing means which are designed for changing the run-out time.

The provision of the measures in accordance with the invention has the advantageous result that the modular unit can be stopped even during the operating time of the arrangement. Furthermore, the advantage is obtained that in relation to the modular unit that is recently to be started within the run-out time, delays, which are unpleasant and incomprehensible to the user of the arrangement, between a start command and actual starting of the modular unit—as would be virtually unavoidable in the case of a stopped hard disk, for example—are avoided. Furthermore, the advantage is obtained that the run-out time is changeable and can therefore be adapted as flexibly as possible to the respective requirements of a user or to the respective operating states of the arrangement.

It has proved to be particularly advantageous in the case of an arrangement according to the invention when the stopping means have counting means which are designed for counting start/stop cycles of the modular unit, and when the changing means are designed for changing the run-out time as a function of the counted start/stop cycles, such that in the practical operation of the arrangement consideration is always taken of a nominal number of start/stop cycles of the modular unit during a nominal lifetime of the modular unit, thus avoiding running out of the nominal number of the start/stop cycles during the nominal lifetime of the modular unit. Furthermore, the advantage is additionally obtained that after a time interval during which the modular unit was controlled in its stopped state and thereafter no start/stop cycles occurred, it is possible to shorten the run-out time with the aid of the changing means. The shortening of the run-out time results, furthermore, advantageously in the fact that the run-out time of the modular unit, which is possibly incomprehensible to a user of the arrangement but is nevertheless necessary for safe and reliable operation of the arrangement, can be changed to favor a user in accordance with the start/stop cycles actually occurring and, nevertheless, taking account of the nominal number of start/stop cycles referred to for the nominal lifetime of the modular unit.

It has further proved to be particularly advantageous in an arrangement in accordance with the invention when frequency-processing means are provided which are designed for processing the frequency of the occurrence of an operating state of the modular unit, and when the changing means are designed for changing the run-out time as a function of a processing result of the frequency-processing means. This results in the advantage that the run-out time can be changed as a function of the processing result of the frequency-changing means, the processing result of the frequency-processing means representing a usage behavior of a user of the arrangement. Consequently, it is achieved in as advantageous a way as possible that the run-out time is changed as a function of the usage behavior. It is particularly advantageous in this regard when the run-out time is lengthened for operating times in which a frequency situated above a frequency threshold value is calculated. This results for the user of the arrangement in the advantage of ensuring quick availability of the arrangement while avoiding a possibly negative influence of the run-out time on the availability. Furthermore, the advantage is obtained as a result thereof that it is possible to shorten the run-out time for operating times in which the frequency is situated below the frequency threshold value since, referred to the nominal number of start/stop cycles, more start/stop cycles are available for the remaining lifetime up to when the nominal lifetime of the modular unit is reached. The advantage is obtained, furthermore, that it is possible to operate the arrangement in a way which is economical and avoids unnecessary wear of the modular unit and, at the same time, to the greatest possible satisfaction of the user, since the run-out time is changed in accordance with the requirements of the user.

It has proved to be particularly advantageous, furthermore, in an arrangement according to the invention when the frequency-processing means are designed for processing the frequency of the occurrence of the started operating state of the modular unit. The advantage is thereby obtained that, with the aid of processing the frequency of the occurrence of the started operating state, the run-out time can be lengthened for the benefit of the availability of the arrangement to the user for operating times in which it is possible to expect a frequency of the occurrence of the started operating state situated above a frequency threshold value.

It has proved to be advantageous, furthermore, in an arrangement according to the invention when the frequency-processing means are designed for processing the frequency of the occurrence of an operating state of the modular unit within an observation time interval. This results in the advantage that the frequency of an operating state occurring within each observation time interval can be assigned temporally to the respective observation time interval. With regard to the observation time interval, it has proved to be particularly advantageous, furthermore, when different interval lengths are used for neighboring observation time intervals, because this permits to accurately determine the time at which the frequency of a change in operational state exceeds or falls short of a frequency threshold value.

It has proved to be advantageous, furthermore, in an arrangement according to the invention when the frequency-processing means are designed for processing the frequency of a change in operating state of the modular unit within the observation time interval. This results in the advantage that it is possible when processing with the aid of the frequency-processing means to take account not only of static operating state of the modular unit such as, for example, the started operating state or the stopped operating state of the modular unit, but also of changes in operating state. It has proved to be particularly advantageous when the frequency-processing means are designed for processing the frequency of a change in operating state of the stopped operating state into the started operating state. This results in advantages that are similar to those in the case of means designed for processing the frequency of the occurrence of the started operating state. However, the advantage is additionally obtained that it is possible to establish with high accuracy an instant at the beginning of an operating time interval for which it is necessary to ensure quick availability of the modular unit on the basis of the usage behavior.

The invention is explained in more detail below with the aid of three examples of embodiment illustrated in the drawings, but to which the invention is not limited.

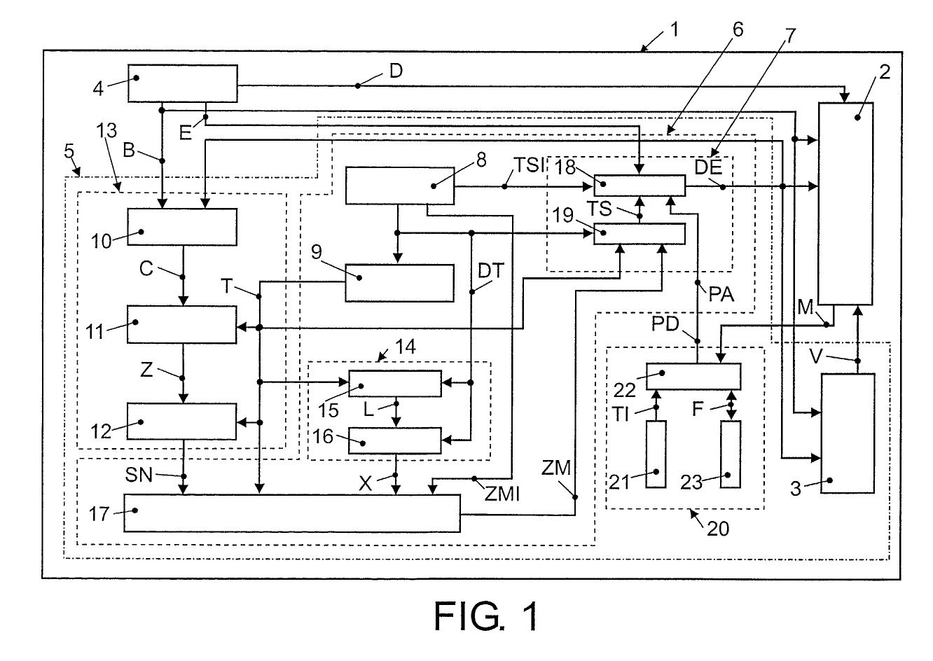

FIG. 1 shows a schematic of a block diagram of an arrangement in accordance with a first example embodiment of the invention,

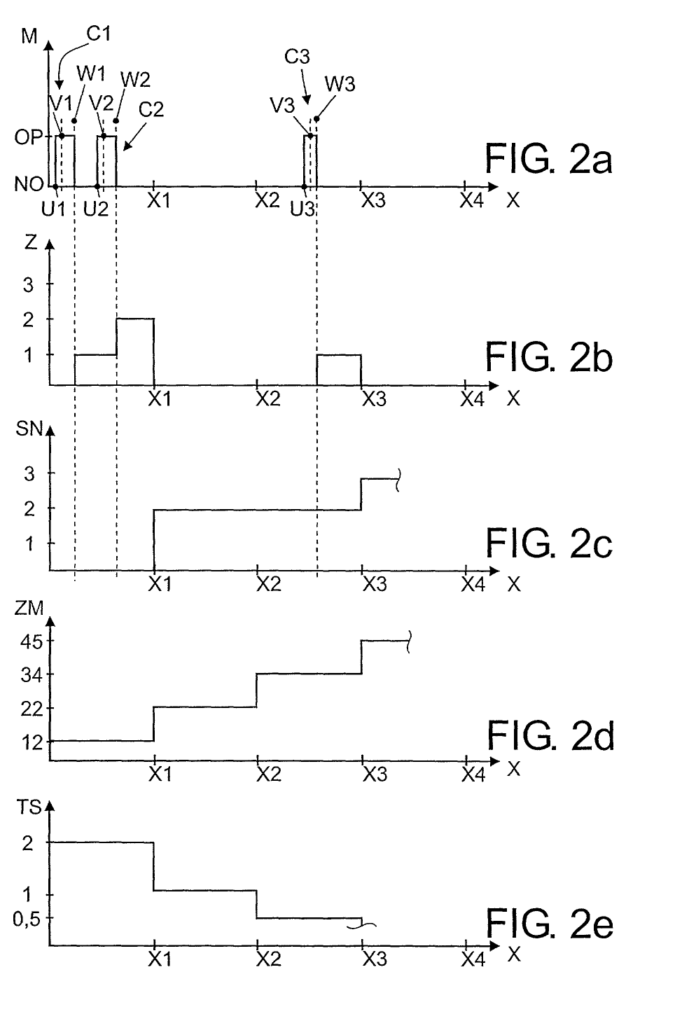

FIG. 2 shows, in the form of five diagrams, the mode of operation of the arrangement in accordance with the first example of embodiment,

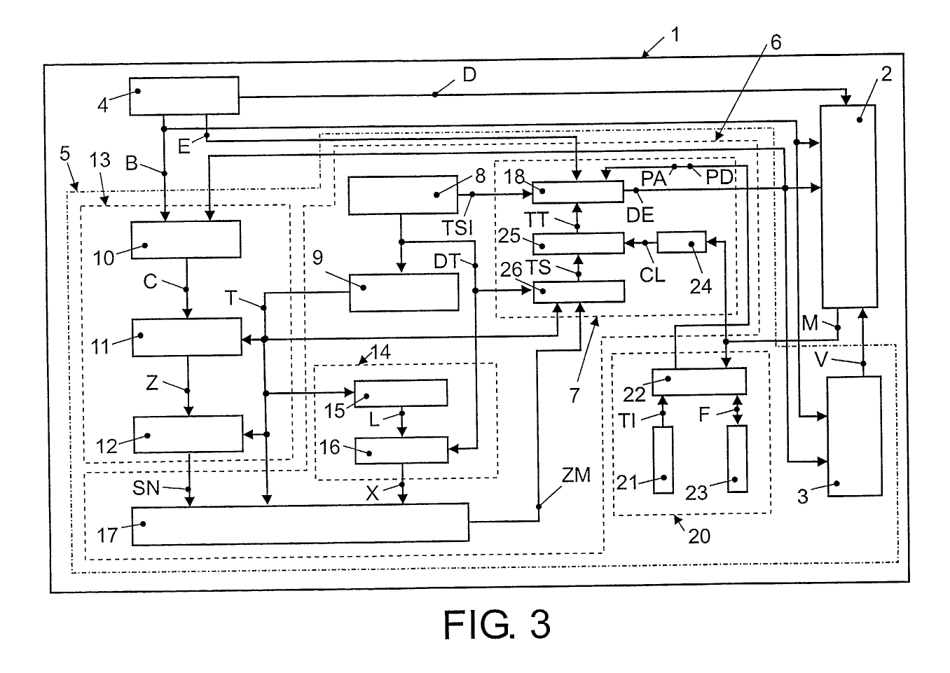

FIG. 3 shows, in the form of a block diagram, an arrangement in accordance with a second example of embodiment,

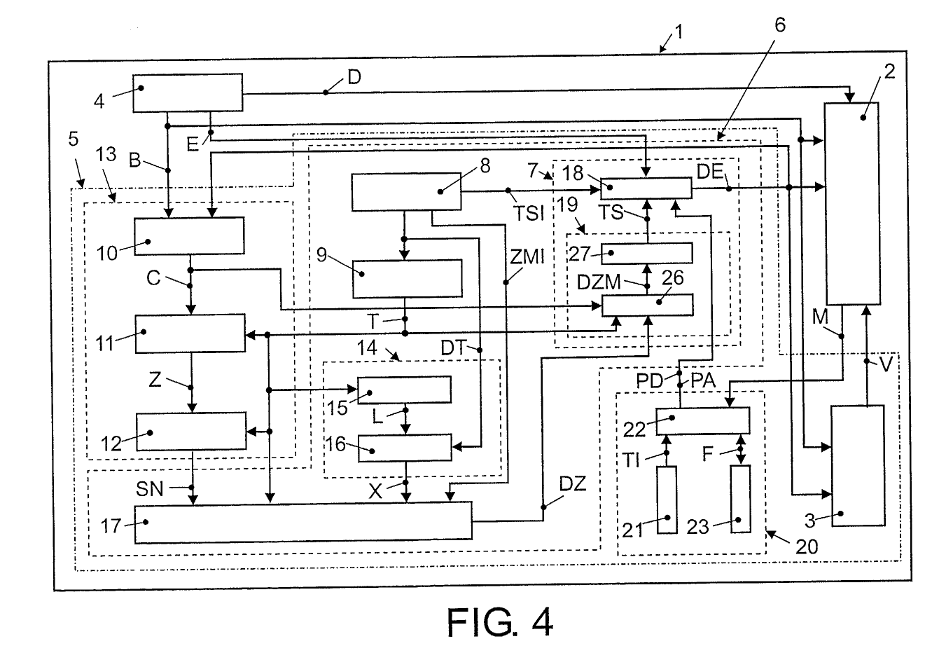

FIG. 4 shows, in the form of a block diagram, an arrangement in accordance with a third example of embodiment, and

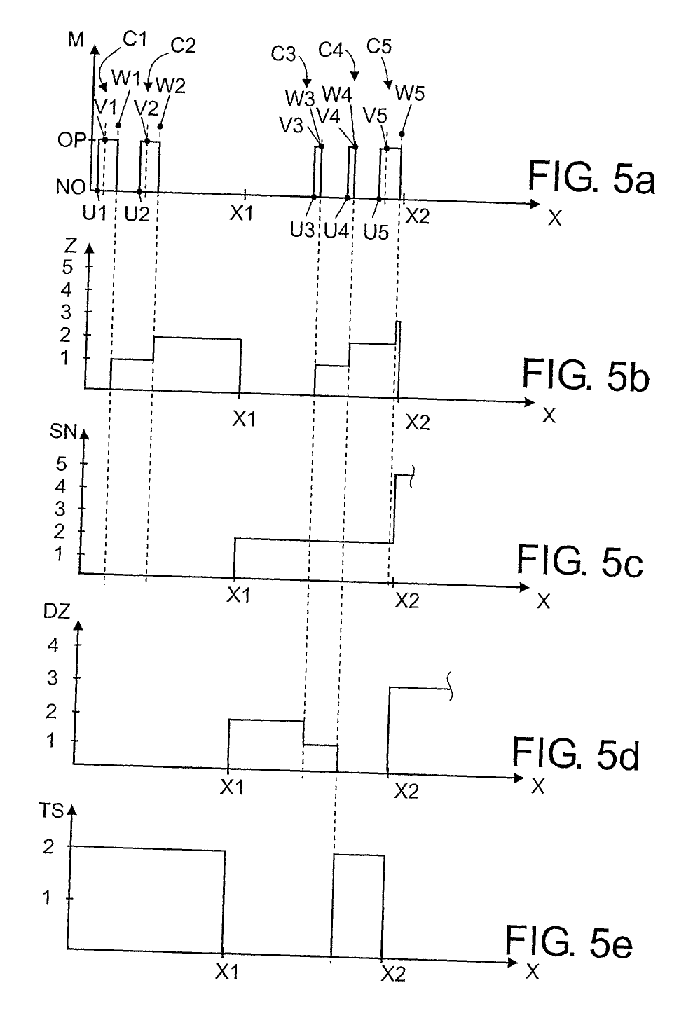

FIG. 5 shows, in the form of five diagrams, the mode of operation of the arrangement in accordance with the third example of embodiment.

Illustrated in FIG. 1 is an arrangement 1 which forms a video recorder for recording and for reproducing video signals. The arrangement 1 can be connected with the aid of a supply connection (not illustrated in FIG. 1) to a supply voltage, or can be disconnected from said supply voltage, such that the arrangement 1 can be activated for an operating time during which the arrangement 1 is connected to the supply voltage.

The arrangement 1 has a modular unit 2 which is formed with the aid of a hard disk and hard-disk electronics belonging to the hard disk and which is designed for recording data D representing video signals, and for reproducing these data D. The modular unit 2 is designed for the purpose of starting the recording and the reproduction of the data D in order to receive an item of starting information B, and for the purpose of stopping the recording and the reproduction of the data D in order to receive an item of stop delay information DE and can therefore be stopped and started. The modular unit 2 is designed, furthermore, for outputting an item of operating state information M which represents the instantaneous operating state of the modular unit 2. The arrangement 1 has, furthermore, modular unit supply means 3 which are designed for generating a modular unit supply voltage V in the presence of a connection of the arrangement 1 to the supply voltage. The modular unit supply means 3 are designed, furthermore, for receiving the starting information B and the stop delay information DE. The modular unit supply means 3 are designed, furthermore, for outputting the modular unit supply voltage V to the modular unit 2, beginning with the reception of the starting information B as far as the reception of the stop delay information DE.

The arrangement 1 further includes interface means 4. The interface means 4 are designed for receiving the video signals and for generating the data D representing the video signals, and for outputting these data D to the modular unit 2, as this is to be performed in recording video signals. The interface means 4 are designed, furthermore, for receiving the data D from the modular unit 2 and for generating and for outputting the video signals representing the data D, as this is to be performed in reproducing data D stored with the aid of the modular unit 2. The interface means 4 are designed, furthermore, for receiving a start command and for generating and for outputting the starting information B as a reaction to the received start command. The interface means 4 are designed, furthermore, for receiving a stop command and for generating and for outputting an item of stop information E as a reaction to the received stop command. For the purpose of receiving the start command and the stop command, the interface means 4 have infrared receiving means (not illustrated in FIG. 1) in order to be able to receive the start command, output to the arrangement 1 by an infrared remote control arrangement (not illustrated in FIG. 1), or the stop command. It may be mentioned in this regard that the interface means 4 can also have keys with the aid of which the stop or start command can be received mechanically. It may further be mentioned in this regard that the interface means 4 also have a data bus with the aid of which the starting or the stop command can be received. It may further be mentioned that the interface means 4 can also have programmable time control means with the aid of which the starting information B and the stop information E can be generated.

The arrangement 1 has stopping means 5 which are designed for stopping the modular unit. For this purpose, the stopping means 5 have delay means 6 which are designed for receiving the stop information B and for delaying the stopping of the modular unit 2 in accordance with a run-out time during the operating time of the arrangement 1, the delay means 6 being designed, after each instant of the occurrence of the stop information E, for outputting with a time delay the stop delay information DE to the modular unit 2 and to the modular unit supply means 3. Furthermore, the stopping means 5 have changing means 7 which are designed for changing the run-out time in accordance with at least one condition.

The delay means 6 have a memory stage 8 which are designed for storing operating constants of the arrangement 1. The operating constants are formed by an item of calculation time interval information DT and by an item of initial cycle number information ZMI and by an item of initial run-out time information TSI. The item of calculation time interval information DT is provided for defining a period of a calculation time interval, it being possible to recalculate the run-out time in each case after this period has expired. The defined period of the calculation time interval can be a tag, for example. The item of initial cycle number information ZMI is provided for defining an initial start/stop cycle number during a first calculation time interval. The initial start/stop cycle number can be defined, for example, with the aid of twelve (12) start/stop cycles during the first calculation time interval. The item of initial run-out time information TSI is provided for defining an initial run-out time during the first calculation time interval. The initial run-out time can be defined, for example, during the first calculation time interval with two (2) hours.

The arrangement 1 further has a timing stage 9 which is designed for reading the calculation time interval information DT out of the memory stage 8. The timing stage 9 is designed, furthermore, for processing the calculation time interval information DT, it being possible to generate and output a timing signal T after the period represented with the aid of the item of calculation time interval information DT has expired. The timing stage 9 is implemented in the present case with the aid of a timer.

The arrangement 1 further has a detection stage 10 and a counting stage 11 and a summing stage 12. The detection stage 10 and the counting stage 11 and the summing stage 12 form counting means 13 which are designed for counting start/stop cycles of the modular unit 2. For this purpose, the counting means 13 can be fed the starting information B and the stop delay information DE. The detection stage 10 is designed for receiving the starting information B and the stop delay information DE. The detection stage 10 is designed, furthermore, for detecting a start/stop cycle, the start/stop cycle being limited at the start by the occurrence of the starting information B and at the end by the occurrence of the stop delay information DE. As a consequence of the detection of a start/stop cycle, the detection stage 10 is designed for generating and for outputting an item of detection information C to the counting stage 11. The counting stage 11 is designed for receiving the detection information C and for receiving the timing signal T. The counting stage 11 is designed, furthermore, for counting the number of the received items of detection information C between the occurrence of two neighboring timing signals T, it being possible to generate an item of counting information Z as the result of the counting of the items of detection information C, and to output it to the summing stage 12. The summing stage 12 is designed for receiving the timing signal T, it being possible upon the reception of the timing signal T for the summing stage 12 to generate an item of summing information SN representing the respective total number of start/stop cycles. The summing stage 12 also has a non-volatile memory (not illustrated in FIG. 1), and so the respectively counted start/stop cycles can be stored as the summing information SN even in the event of disconnection of the arrangement 1 from the supply voltage. The summing stage 12 is designed, furthermore, for outputting the summing information SN.

The arrangement 1 has operating time normalizing means 14 which are designed for calculating the operating time of the arrangement 1 in a fashion normalized to the calculation time interval. For this purpose, the operating time normalizing means 14 have an operating time calculating stage 15 which is designed for receiving the timing signal T and the item of calculation time interval information DT. The operating time calculation stage 15 is designed in the case of each occurrence of the timing signal T for summing the period of the calculation time interval represented with the aid of the item of calculation time interval information DT. Furthermore, the operating time calculation stage 15 has a non-volatile memory (not illustrated in FIG. 1) for storing the calculated operating time. The operating time calculation stage 15 is designed for generating and for outputting an item of operating time information L which represents the operating time and which can be output to a normalizing stage 16. The normalizing stage 16 is designed, furthermore, for receiving the calculation time interval information DT. Furthermore, the normalizing stage 16 is designed for calculating the normalized operating time, it being possible to divide a value formed with the aid of the items of operating time information L by a value formed with the aid of the items of operating time interval information DT. In this case, the normalizing stage 16 is designed for generating and outputting a normalized item of operating time information X. It may be mentioned that the operating time normalizing means 14 can also be designed exclusively for summing the timing signals T that have occurred, and for storing the normalized operating time information X thus formed and for outputting this normalized operating time information X.

The arrangement 1 further has a determining stage 17 which is designed for receiving the summing information SN and the timing signal T and the normalized operating time information X and the initial cycle number information ZMI. The determining stage 17 is designed, furthermore, for calculating and for outputting an item of maximum cycle number information ZM at any instant of the occurrence of a timing signal T on the basis of the summing information SN and the normalized operating time information X and the initial cycle number information ZMI. The item of maximum cycle number information ZM represents the maximum number of available start/stop cycles of the modular unit 2 during the calculation time interval following the instant of a timing signal T and taking account of the number, represented with the aid of the summing information SN, of start/stop cycles of the modular unit 2, which have already occurred during the operating time of the arrangement 1 that has expired before the instant of the timing signal T. The following formula is applied when calculating the item of maximum cycle number information ZM.

ZM=ZMI(X+1)−SN

The item of maximum cycle number information ZM calculated in accordance with this formula can be output to the changing means 7. The changing means 7 have a stop delay stage 18 and run-out time calculating means 19. The run-out time calculating means 19 are designed for receiving the calculation time interval information DT and the timing signal T and the maximum cycle number information ZM.

The run-out time calculating means 19 are designed for calculating the run-out time at the instant of the reception of the timing signal T as a function of the maximum cycle number information ZM, a value represented with the aid of the calculation time interval information DT being divided in the case of the run-out time calculating means 19 by a value represented with the aid of the maximum cycle number information ZM. It is possible in this case to generate an item of run-out time information TS which represents the run-out time. The run-out time calculating means 19 are adapted to supply the run-out time information TS to the stop delay stage 18.

The stop delay stage 18 is designed for receiving the stop information E and the initial run-out time information TSI and the run-out information TS and a profile activity signal PA and a profile deactivate signal PD. More detail is given below on the profile activity signal PA and the profile deactivate signal PD. As a consequence of the reception of the stop information E, the stop delay stage 18 is designed for generating the stop delay information DE. Furthermore, the stop delay stage 18 is designed, as a function of the delaying time, for the delayed output of the stop delay information DE to the modular unit 2 and to the modular unit supply means 3 and to the counting means 13. The stop delay stage 18 is designed, furthermore, for deciding whether the timer 9 processes the first calculation time interval after the arrangement 1 has been taken into operation for the first time. For this case, the run-out time transmitted with the aid of the initial run-out time information TSI to the stop delay stage 18 is used to output the stop delay information DE in delayed fashion. The processing of the first calculation time interval therefore forms with the timer 9 a first condition for the changing means 7 for changing the run-out time.

Furthermore, the stop delay stage 18 is designed in the case of reception of the profile activity signal PA for outputting the stop delay information DE in delayed fashion in accordance with a run-out time that is independent of the run-out time information TS. In the present case, this run-out time which is independent of the run-out time information TS, is formed with the aid of the initial run-out time information TSI. The reception of the profile activity signal PA therefore forms a second condition for the changing means 7 for changing the run-out time.

For the case where the profile deactivate signal PD is received by the stop delay stage 18, and the timer 9 does not process the first calculation time interval after the initial operation of the arrangement 1, the changing means 7 are designed for changing the run-out time as a function of the counted start/stop cycles and, consequently, as a function of the maximum cycle number information ZM determined therefrom. The number of the counted start/stop cycles therefore forms a third condition for the changing means 7 for changing the run-out time.

The arrangement 1 further has frequency-processing means 20. The frequency-processing means 20 have an observation time interval generator 21 which is designed for generating and for outputting an item of observation time interval information TI. The observation time interval information TI represents times of day in the present case. The frequency-processing means 20 further have a frequency-processing stage 22 which is designed for receiving the observation time interval information TI and for receiving the operating state information M. The frequency-processing stage 22 is respectively designed for detecting operating states of the modular unit 2 received with the aid of the operating state information M, doing so at the instant of reception of the observation time interval information TI. The frequency-processing means 20 further have a frequency memory stage 23 which is designed for storing the operating state information M of the modular unit 2 present at the instants of the occurrence of the observation time interval information TI. For this purpose, the frequency-processing stage 22 is designed for logging the operating states of the modular unit 2 in the frequency memory stage 23, doing so during an observation phase which can, for example, comprise a multiplicity of days. The frequency-processing stage 22 is designed for processing, after conclusion of this observation phase, the frequency of the operating states of the modular unit 2 occurring at the respective times of day. In this case, the frequency-processing stage 22 is initially designed for calculating a frequency of the stored operating state information M at the respective times of day. The frequency-processing stage 22 is designed, furthermore, for tabular storage of the frequency together with the respective times of day in the form of frequency information F in the frequency memory stage 23. Consequently, the frequency-processing stage 22 is designed to check at the times of day represented with the aid of the observation time interval information TI whether the frequency information F stored in the frequency memory means 23 represents a value which is greater than a frequency threshold value. The frequency-processing stage 22 is designed for generating and for outputting the profile activity signal PA given the presence of a value of the frequency information F which is greater than a frequency threshold value. For the case where the value of the frequency information F is less than the frequency threshold value, the frequency-processing stage 22 is designed for outputting a profile deactivate signal PD. The profile activity signal PA and the profile deactivate signal PD form a processing result of the frequency-processing means 20. Consequently, the changing means are designed for changing the run-out time 7 as a function of the processing result of the frequency-processing means 20, which processing result therefore forms a further condition for the changing means 7.

In the present case, the frequency-processing stage 22 is preferably designed for processing the started state of the modular unit 2, such that the run-out time can be changed with the aid of the changing means 7 as a function of a frequency of the started state of the modular unit 2.

In the text which follows, a first example of application is now used to explain the mode of operation of the arrangement 1 in accordance with the first example of embodiment of the invention with the aid of FIG. 2.

In accordance with this example of application, it may be supposed that a nominal number of 50,000 start/stop cycles of the modular unit 2 is prescribed by a manufacturer of the modular unit 2. In the case of a required nominal lifetime of approximately 11.4 years for the modular unit 2, this results in an average run-out time of two hours in order to ensure during the nominal lifetime that the nominal number of start/stop cycles is not exceeded. It may be predicted, furthermore, that the items of calculation time interval information DT are to represent an entire day, that is to say, 24 hours. An initial cycle number of twelve start/stop cycles per day results on the basis of the calculation time interval of 24 hours and an initial run-out time of two hours.

When the arrangement 1 is initially taken into operation, the initial run-out time information TSI, which represents the initial run-out time of two hours, is firstly output to the stop delay stage 18. Furthermore, the calculation time interval information DT, which represents 24 hours, is output to the timer 9. The timer 9 is designed thereupon for generating the timing signal T in the 24 hour cycle. Furthermore, the calculation time interval information DT is output to the run-out time calculating means 19 and to the operating time calculating stage 15 and to the normalizing stage 16, in order to permit the respective calculations.

Five diagrams are illustrated in FIG. 2. Illustrated in FIG. 2a is a first diagram, in which the operating state information M is plotted against the normalized operating time information X. Illustrated in FIG. 2b is a second diagram, in which the counting information Z is plotted against the normalized operating time information X. Illustrated in FIG. 2c is a third diagram, in which the summing information SN is plotted against the normalized operating time information X. Illustrated in FIG. 2d is a fourth diagram, in which the maximum cycle number information ZM is plotted against the normalized operating time information X. Illustrated in FIG. 2e is a fifth diagram in which the run-out time information TS is plotted against the normalized operating time information X.

In accordance with the first example of application, shortly after its initial operation, the arrangement 1 according to the invention is in its stopped state NO, as is illustrated in FIG. 2a. At this instant, the maximum cycle number information ZM represents the value of twelve (12) which also forms the initial cycle number and which is plotted in FIG. 2d. The value of twelve (12) of the initial cycle number is valid, in accordance with FIG. 2d, during an operating time interval between the initial operation of the arrangement 1 and the instant at which the normalized operating time information X assumes the value X1.

The value X1 specifies the instant when the first operating day of the arrangement 1 expires. Similarly, the value X2 specifies the expiry of the second operating day of the arrangement 1, and the value X3 specifies the expiry of the third operating day of the arrangement 1, and the value X4 specifies the expiry of the fourth operating day of the arrangement 1. Consequently, the normalization of the operating time refers to the unit of days.

During the first operating day, the initial run-out time is two hours, as is plotted in FIG. 2e for the time interval between the initial operation of the arrangement 1 and the expiry of the first operating day. During the first operating day, the starting information B is now generated at the instant U1 plotted in FIG. 2a and output by the interface means 4 to the detection stage 10. The detection stage 10 detects the starting information B and is designed from now on for detecting stop delay information DE. The starting information B is likewise output to the modular unit 2 and to the modular unit supply means 3, such that, once the modular unit supply voltage V has been output to the modular unit 2, the modular unit 2 changes from its stopped state NO illustrated in FIG. 2a into the started state OP. The stop information E is generated at the instant V1 illustrated in FIG. 2a and output to the stop delay stage 18 by the interface means 4. Since the timer 9 is in the state of processing the first calculation time interval after the initial operation of the arrangement 1, and because the frequency-processing stage 22 outputs the profile deactivate signal PD to the stop delay stage 18, the stop delay stage 18 performs a delayed output of the stop delay information DE in accordance with the initial run-out time, plotted in FIG. 2e, of two hours. The effect of this delay is that the modular unit 2 does not change from its started state OP into the stopped state NO until the instant W1 plotted in FIG. 2a. The occurrence of the stop delay information DE is detected at the instant W1 by the detection stage 10, and so a complete start/stop cycle, which is marked in FIG. 2a with the reference symbol C1, is detected. Consequently, the detection information C is output by the detection stage 10 to the counting stage 11. The counting stage 11 uses the detection information C to generate the counting information Z, the counting information Z assuming the value of one (1) plotted in FIG. 2b after the occurrence of the first complete start/stop cycle C1. During operation of the arrangement 1, the starting information B is regenerated during the first day at the instant U2 plotted in FIG. 2a such that the modular unit 2 changes its state again from the stopped state NO into the started state OP. The stop information E is regenerated at the instant V2, the modular unit 2 not changing from its started state OP into its stopped state NO in accordance with the initial run-out time of two hours until the instant W2 plotted in FIG. 2a. As a consequence of the detection of the second start/stop cycle, which is marked in FIG. 2a with the reference symbol C2, at the instant W2 the counting information Z plotted in FIG. 2b assumes the value of two (2). The summing stage 12 takes over from the counting stage 11 the value of two (2) represented with the aid of the counting information Z at the instant of the generation and outputting of the timing signal T by the timer 9, that is to say at the instant X1, plotted in FIG. 2a, after the first day has expired. The value of two (2) represented with the aid of the summing information SN and illustrated in FIG. 2c at the instant X1 is fed to the determining stage 17. On the basis of the formula for calculating the maximum cycle number information ZM, the determining stage 17 calculates a maximum number, valid for the second day of operation of the arrangement 1, of start/stop cycles and outputs it to the run-out time calculating means 19 in a fashion represented by the maximum cycle number information ZM. The maximum cycle number information ZM represent the value of twenty-two (22) at the instant X2 plotted in FIG. 2d. Consequently, as is illustrated in FIG. 2e, the run-out time information TS representing the value (24/22) hours is calculated by the run-out time calculating means 19.

As is illustrated in FIG. 2a, no new start/stop cycles occur during the second operating day of the arrangement 1, and so after the second day has expired the summing information SN illustrated in FIG. 2c represents as before the value of two (2) at the instant X2. Consequently, as is illustrated in FIG. 2d, the maximum cycle number information ZM representing the value of thirty-four (34) is generated at the instant X2 with the aid of the formula for calculating the maximum cycle number information ZM. On the basis of the maximum cycle number information ZM, the run-out time calculating means 19 calculates the run-out time information TS for the third operating day of the arrangement 1 and outputs it to the stop delay stage 18, which run-out time information TS represents a value of (24/34) hours.

The starting information B, which effects a change in the operating state of the modular unit 2 from the stopped state NO into the started state OP, is regenerated at an instant U3 plotted in FIG. 2a. The stopping information E, which is output to the stop delay stage 18, is regenerated at the instant V3. The stop delay stage 18 is now used in accordance with the run-out time of (24/34) hours valid for the third day to output the stop delay information DE to the modular unit 2 and to the modular unit supply means 3 at an instant W3 such that the modular unit 2 changes its operating state from the started state OP into the stopped state NO.

This change in the operating state is detected by the counting means 13, as a result of which after the third operating day has expired the summing information SN represents the value of three (3), and as a result a maximum cycle number information ZM at the instant X3 represents the value of forty-five (45). This results in a run-out time of the fourth operating day which has a smaller value than the value for the run-out time which was valid for the third operating day.

During an operating time of thirty days, the frequency-processing means 20 log the operating state information M, which is present at specific times of day of one day, which have a spacing of fifteen (15) minutes in each case and are represented by the observation time interval information TI, and also logs the respectively associated observation time interval information TI in the frequency memory means 23. After the thirtieth operating day has expired, the frequency-processing stage 22 calculates the frequency of the started state of the modular unit 2 at the respective times of day. The frequency of the started state of the modular unit 2 is stored, together with the respective times of day, in the form of the frequency information F in the frequency memory stage 23, and thereby forms a usage profile of the arrangement 1. This usage profile represents the typical frequency of the use of the arrangement 1 by an individual user or a group of users during an operating day. Beginning with the thirty-first operating day of the arrangement 1, at the times of day generated with the aid of the observation time interval information TI, the frequency-processing stage 22 is used to compare with a frequency threshold value the values, represented by the frequency information F at the respective times of day, of frequencies of the started state of the modular unit 2. It is assumed in the present case that beginning from ten o'clock in the morning up to 11.30 in the morning the frequency of the started state of the modular unit 2 has a value which is greater than the frequency threshold value. The frequency-processing stage 22 generates the profile activity signal PA for this period between 10 o'clock and 11.30 in the morning and outputs it to the stop delay stage 18. Thereupon, after receiving the stop information E, the stop delay stage 18 performs delayed generation and outputting of the stop delay information DE in accordance with the initial run-out time information TSI. This ensures that for an operating time interval for which it is possible to expect a user will be more likely to use the arrangement 1, a run-out time is applied which is greater than the run-out time provided for the operating day under consideration and represented by the run-out time information TS. Unnecessary start/stop cycles for these operating time intervals are thereby avoided. It may be mentioned that, given the presence of the profile activity signal PA, the stop delay stage 18 can be designed for suppressing the output of the stop delay information DE such that stopping of the modular unit 2 is avoided in this case.

An arrangement 1 in which the changing means 7 additionally have time-measuring means 24 and decision means 25 is illustrated in FIG. 3.

The time-measuring means 24 are designed for receiving the operating state information M and for detecting a change in operating state of the modular unit 2 from the stopped state into the started state. The time-measuring means 24 are designed, furthermore, to measure that expired time interval which begins with the respective occurrence of a started state OP, plotted in FIG. 2a with the aid of the reference symbols U1, U2 and U3, of the modular unit 2, and which ends with a respective occurrence of an instant, plotted in FIG. 2a with the aid of the reference symbols V1, V2 and V3, of the occurrence of the stop information E. The time-measuring means 24 are designed, furthermore, for outputting to the decision means 25 an item of time-measuring information CL representing this expired time interval.

The decision means 25 are designed for receiving the time-measuring information CL and for receiving the run-out time information TS. The decision means 25 are further designed for calculating a difference value which results by subtraction from the run-out time represented by the run-out time information TS and from the value represented by the time-measuring information CL. The decision means 25 are designed, furthermore, on the basis of this difference value for generating and for outputting an item of correction run-out time information TT. For the case where the difference value is greater than the value of zero, the correction run-out time information TT represents the difference value. For the case where the difference value is less than or equal to the value of zero, the correction run-out time information TT represents a run-out time of the value zero, such that the stop delay stage 18 can carry out the outputting of the stop delay information DE immediately upon the reception of the stop information E. The advantageous result is therefore that the run-out time can be calculated with reference to the instants of the occurrence of the started state OP plotted in FIG. 2a, of the modular unit 2, that is to say with reference to the instants U1, U2, and U3.

FIG. 4 illustrates an arrangement 1 in which the determining stage 17 is designed for determining the surplus number of start/stop cycles, specifically of start/stop cycles within the operating time interval present after the occurrence of the timing signal T, referred to the maximum number of start/stop cycles available in this operating time interval. In the case of this determination, the determining stage 17 is designed for generating, and for outputting to the run-out time calculating means 19, an item of surplus cycle information DZ representing the surplus number, it being possible to apply the formula specified below, specifically:

DZ=ZMI·X−SN.

The run-out time calculating means 19 have a surplus-decrementing stage 26 and a decision stage 27. The surplus-decrementing stage 26 is designed for receiving the detection information C and the timing signal T and the surplus cycle information DZ. The surplus-decrementing stage 26 is further designed in the case of reception of the timing signal T for buffering the surplus cycle information DZ, received by the determining stage 17 in memory means which are not, however, illustrated in FIG. 4. Furthermore, the surplus-decrementing stage 26 is designed for decrementing the surplus number, represented with the aid of the surplus cycle information DZ, of start/stop cycles by unity (1) as soon as the detection information C has been received by it. In this case, the surplus-decrementing stage 26 is designed for generating and for outputting an item of correction surplus cycle information DZM to the decision stage 27. The decision stage 27 is designed for deciding as to whether the correction surplus cycle information DZM represents a value which is greater than the value of zero.

In the case where the item of correction surplus cycle information DZM represents a value that exceeds zero, the decision stage 27 is designed for outputting the run-out time information TS, which represents a value of zero for the run-out time. Consequently, the stop delay stage 18 is designed for immediately outputting the stop delay information DE to the modular unit 2 as a consequence of the reception of the stop information E.

In the case where the item of correction surplus cycle information DZM represents a value that is smaller than or equal to zero, the decision stage 27 is designed for outputting the run-out time information TS which represents a run-out time which is formed by the initial run-out time information TSI. Consequently, the stop delay stage 18 is designed, upon reception of this run-out time information TS, for outputting the stop delay information DE in a delayed fashion to the modular unit 2 in accordance with the initial run-out time.

The frequency-processing stage 22 is designed, during an observation time interval fixed with the aid of the observation time interval information TI, for detecting operating states of the modular unit 2 received with the aid of the operating state information M. The operating state information M is evaluated during detection with reference to a change in operating state of the modular unit 2 from the stopped operating state into the started operating state. The frequency-processing stage 22 is further designed during the observation time interval for summing these changes in operating state and for storing as frequency information F the frequency of the changes occurring in an operating state in the frequency memory stage 23 together with the observation time interval information TI characterizing the observation time interval. Consequently, the frequency processing means 20 are designed for processing the frequency of the occurrence of the change in operating state of the modular unit 2 within the observation time interval.

The mode of operation of the arrangement 1 in accordance with the third example of embodiment of the invention is now explained below with the aid of FIG. 5, with reference to a second example of application.

It may be presupposed in accordance with this second example of application that a maximum number of four (4) start/stop cycles available in a respective operating time interval are presupposed.

Illustrated in FIG. 5a is a diagram in which the operating state information M is plotted against the normalized operating time information X. Illustrated in FIG. 5b is a diagram in which the counting information Z is plotted against the normalized operating time information X. Illustrated in FIG. 5c is a diagram in which the summing information SN is plotted against the normalized operating time information X. Illustrated in FIG. 5d is a diagram in which the surplus cycle information DZ is plotted against the normalized operating time information X. Illustrated in FIG. 5e is a diagram in which the run-out time information TS is plotted against the normalized operating time information X.

In accordance with FIG. 5, the mode of operation of the arrangement 1 for the first operating time interval between the instant at which the arrangement 1 is taken into operation for the first time and the expiry of the first operating time interval up to the occurrence of the instant X1 is identical to the mode of operation of the arrangement in accordance with FIG. 1, and so this will not be examined in more detail. In the first operating time interval, the surplus cycle information DZ represents the value of zero, and the run-out time information TS represents a run-out time of two hours. At the instant X1, the counting information Z represents the value of two (2) as is illustrated in FIG. 5b, since the two operating cycles C1 and C2 have occurred during the first day of operation. This value is taken over by the summing stage 12 so that the summing information SN at this instant likewise represents a value of two (2). Since the maximum number of start-stop cycles available in an operating time interval is given as four (4), the determining stage 17 calculates a surplus number of two start-stop cycles for the second operating time interval between the instant X1 and the instant X2, so that the surplus cycle information DZ represents the value of two (2) at the beginning of the second operating time interval, as is illustrated in FIG. 5d.

The starting information B is generated at the instant U3. The stop information E is generated at the instant V3, and so the detection information C is generated by the detection stage 10. Since at the instant of the detection of the third start/stop cycle C3 illustrated in FIG. 5a the correction surplus cycle information DZM represents the value of two (2), the decision stage 27 outputs the run-out time information TS to the stop delay stage 18, which represents the value of zero, as is illustrated in FIG. 5e. The stop delay stage 18 therefore outputs the stop delay information DE to the modular unit 2 immediately after the reception of the stop information E, and this is illustrated in FIG. 5a by the temporal coincidence of the instants V3 and W3.

The detection information C is received by the surplus-decrementing stage 26, whereupon the surplus cycle information DZ representing the value of two (2) is decremented by the value of one (1) so that the surplus cycle information DZ represents the value of one (1).

In the case of a renewed occurrence of a start/stop cycle, as illustrated in FIG. 5a with a fourth start/stop cycle C4, the decision stage 27 again outputs the run-out time information TS, which represents the value of zero, so that the stop delay information DE to be generated and output by the stop delay stage 18 is output immediately upon the reception of the stop information E to the modular unit 2. The surplus decrementing stage 26 is used to decrement the surplus cycle information DZ, representing the value of one (1), again by unity (1), as a result of which the surplus cycle information DZ now represents the value of zero, and this is further reported to the decision stage 27 with the aid of the correction surplus cycle information DZM.

Upon the occurrence of a fifth start/stop cycle C5, as illustrated in FIG. 5a, upon the occurrence of the stop information E at the instant V5, the run-out time information TS is now output to the stop delay stage 18, which represents a run-out time which is equal to the initial run-out time, as is illustrated in FIG. 5e. Since a further three start/stop cycles have occurred during the second operating time interval between the instant X1 and the instant X2, beginning at the instant X2 the determining stage 17 determines for the third operating time interval the surplus cycle information DZ, which represents a surplus number of three start/stop cycles, as illustrated in FIG. 5d. Consequently, three start/stop cycles with a run-out time representing the value of zero can occur for the third operating time interval before the run-out time once again has a value of two hours.

1. An arrangement which can be activated for an operating time and which includes a modular unit that can be started and stopped, and which includes stopping means which are designed for stopping the started modular unit, the stopping means having delay means which are designed for delaying the stopping of the modular unit in accordance with a run-out time during the operating time of the arrangement, and the stopping means having changing means which are designed for changing the run-out time.

2. The arrangement as claimed in claim 1, in which the stopping means have counting means which are designed for counting start/stop cycles of the modular unit, and in which the changing means are designed for changing the run-out time as a function of the counted start/stop cycles.

3. The arrangement as claimed in claim 2, in which frequency-processing means are provided which are designed for processing the frequency of the occurrence of an operating state of the modular unit, and in which the changing means are designed for changing the run-out time as a function of a processing result of the frequency-processing means.

4. The arrangement as claimed in claim 3, in which the frequency-processing means are designed for processing the frequency of the occurrence of the started operating state of the modular unit.

5. The arrangement as claimed in claim 3, in which the frequency-processing means are designed for processing the frequency of the occurrence of an operating state of the modular unit within an observation time interval.

6. The arrangement as claimed in claim 5, in which the frequency-processing means are designed for processing the frequency of the occurrence of a change in operating state of the modular unit within the observation time interval.
